(19) United States
(12) Patent Application Publication
(10) Pub. No.: US 2005/0091894 A1
(43) Pub. Date: May 5, 2005

(54) Counterpoise constricting disassemblable signage system with foot-actuated interdigitation for different constructs

(76) Inventors: Richard L. Hamilton, Phoenix, AZ (US); Margaret L. Hamilton, Phoenix, AZ (US)

Correspondence Address: TOD R. NISSLE, P.O. Box 55630, Phoenix, AZ, 85078, US

(21) Appl. No.: 10/698,133

(22) Filed: Oct. 31, 2003

(51) Int. Cl. G09F 15/00

(52) U.S. Cl. 40/610

(57) ABSTRACT

A signage system includes a folding A-frame sign and at least one ground engaging support that is used when the sign is in its deployed, unfolded orientation. The support interdigitates the deployed sign to constrict and stiffen the sign and to prevent the sign from folding and collapsing and from being laterally displaced. In addition, the support functions as lever that utilizes the weight of the sign to minimize the likelihood that the sign will tip over when subjected to an extraneous force. A user can, while standing, readily attach the support to the sign by utilizing one of his or her feet. The support can be used with different sign constructs.

This invention pertains to signage.

More particularly, the invention pertains to a counterpoise method and apparatus to engage and constrict movable legs on signage to prevent the collapse of the legs when the signage is subjected to wind or other extraneous forces.

In a further respect, the invention pertains to a signage system that facilitates the assembly of a sign by a user while the user is standing.

In another respect, the invention pertains to a signage system that incorporates a structural component that functions as a lever when tipped on the ground and that utilizes the weight of a sign to operate the lever and generate a force that works to force the lever toward the ground.

In still a further respect, the invention pertains to a signage system that facilitates supporting signs of varying construct.

Folding signs are common.

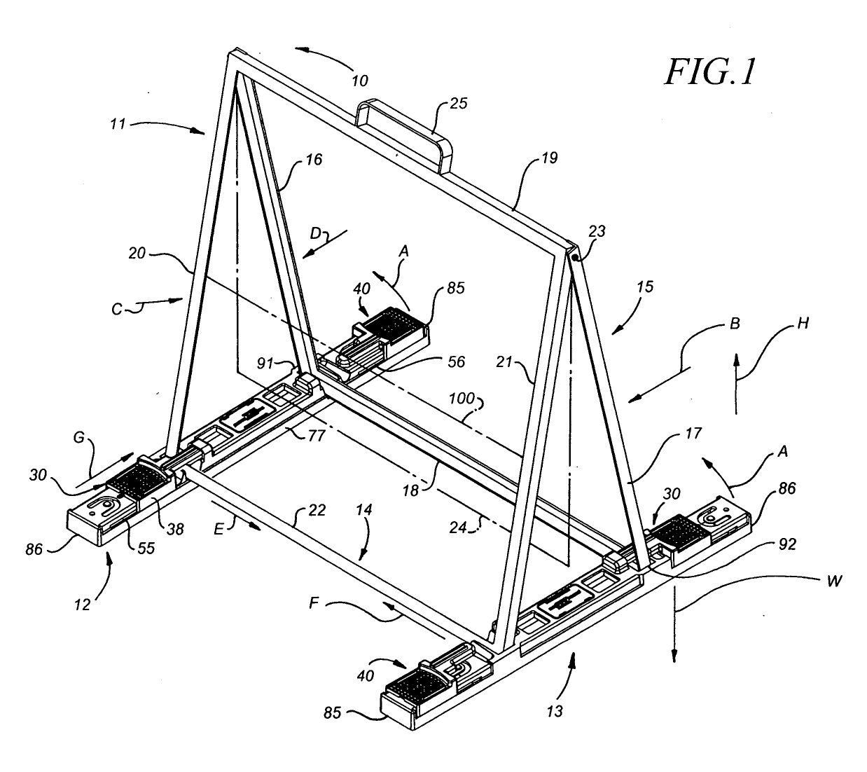

A first kind of folding sign is a rectangular frame sign that is illustrated in FIG. 1 and utilizes a frame that includes a U-shaped frame member hinged to a rectangular open frame member such that when the sign is in its open, unfolded configuration and is viewed from the side, the frame has an “A” shape, i.e., the frame has the appearance of an A-frame. The rectangular frame member includes a pair of spaced apart vertically oriented legs 20 and 21, a horizontal top member 19 attached to the upper ends of the legs, and a horizontal bottom member 22 attached to the lower ends of the legs. The U-shaped frame member includes a pair of vertically oriented legs 16, 17 and a horizontal bottom member 18 attached to the lower ends of the legs. The bottom of the frame members contact the ground to form a footprint. The footprint of a sign comprises the area defined by the points at which the sign contacts the ground when placed on the ground. A thin display panel is suspended and hangs from the top of the frame and is normal to the ground. Alphanumeric characters and artwork is typically imprinted or formed on either face of the display panel. The rectangular frame member is open (as is the U-shaped member)—like a picture frame—to permit the faces of the display panel to be readily viewed. This first kind of sign is routinely used by real estate agents who are conducting open houses in homes that the agents are attempting to sell.

A second kind of folding sign is the so-called sandwich board sign. This sign is comprised of a pair of rectangular panels. Each rectangular panel has an inner face that opposes the inner face of the other panel and has an outer face. Alphanumeric characters or artwork are formed on the outer face of each panel. Each panel also includes a ground-engaging lower edge and an upper edge. The lower and upper edge of the panel ordinarily are parallel. The upper edge of one panel is tied or otherwise hinged to the upper edge of the second panel to permit the lower edges of the panels to be spread apart such that the panels take on an A-frame shape. The sandwich board sign can be erected with the lower panel edges contacting the ground. In this configuration, the sign is usually free standing. Another method of using a sandwich board sign is for a person to “wear” the sign. In this method of use, the upper edges of the rectangular members are loosely tied so that a person's head will fit between the upper edges.

A third kind of folding sign is the so-called H-frame sign. The H-frame sign is similar to the rectangular frame sign except that the horizontal bottom member 14 that is located at the lower ends of the legs 20, 21 of the rectangular frame member in the rectangular frame sign is eliminated and is replaced by a horizontally oriented member 100 (FIG. 1) that extends between and is connected to the middle portions of the legs 20, 21. Similarly, in an H-frame sign, the U-shaped horizontal member 18 attached to the lower ends of the spaced apart legs 16, 17 is eliminated and is replaced by a horizontal member that extends between and is connected to the middle portion of the legs 16, 17, much like the horizontal member in the letter “H” extends between and connects the middle portions of the legs of the letter H. When the H frame sign is in its open unfolded configuration and is viewed from the side, the H frame sign—like the rectangular frame sign—has the appearance of an A-frame.

One problem associated with A-frame signs and other folding signs is that they often can be readily blown or tipped over. This is particularly aggravating for a real estate agent because the agent usually is not within view of the sign or signs that he or she is using for an open house. As a result, the agent often does not know the sign has tipped over until the agent has finished the open house and is picking up the sign to leave. One solution to this problem is to use sandbags, or rocks, or other ballast to weigh down the legs of the sign. Real estate agents are disinclined to use such, however, because sandbags and rocks are bulky, can drag debris into an automobile of a real estate agent, can slide or fall off signs, and are heavy. Back injuries are increasingly common in the United States because many American do not have the inclination or time to exercise. Bending down to put sandbags or rocks on the feet of a sign aggravates and incurs back injuries on a regular basis.

Sandwich board signs are often more prone to be blown over than are the signs real estate agents use because the sandwich board signs are taller. Using sandbags and rock to secure a sandwich board sign normally is not practical.

As used herein, an A-frame sign is a sign that includes at least a pair of folding legs that move between a folded closed position and an unfolded open position and that, when in the unfolded open position and viewed from the side, have a shape that generally corresponds to an A-frame shape.

Accordingly, it would be highly desirable to provide an improved signage system and method to minimize the likelihood that folding signs and other signs will collapse, will be blown over, or will otherwise be tipped over.

Therefore, it is a principal object of the invention to provide an improved signage system and method for using the same.

Another object of the invention is to provide a counterpoise folding A-frame sign system that can be installed without requiring an individual to bend over and or to manipulate heavy weight.

A further object of the invention is to provide a counterpoise sign support system that more efficiently utilizes the weight of a sign to maintain the sign in an upright orientation.

Still another object of the invention is to provide an improved sign support system that secures a folding sign in an unfolded configuration by constricting movement of the legs of the sign.

Still a further object of the invention is to provide an improved sign support system that interdigitates with signs of varying shape and dimension.

Yet another object of the invention is to provide an improved sign support system that can be used to control lateral displacement of a sign.

These and other, further and more specific objects and advantages of the invention will be apparent to those skilled in the art from the following detailed description thereof, taken in conjunction with the drawings, in which:

FIG. 1 is a perspective view illustrating a signage system constructed in accordance with the principles of the invention;

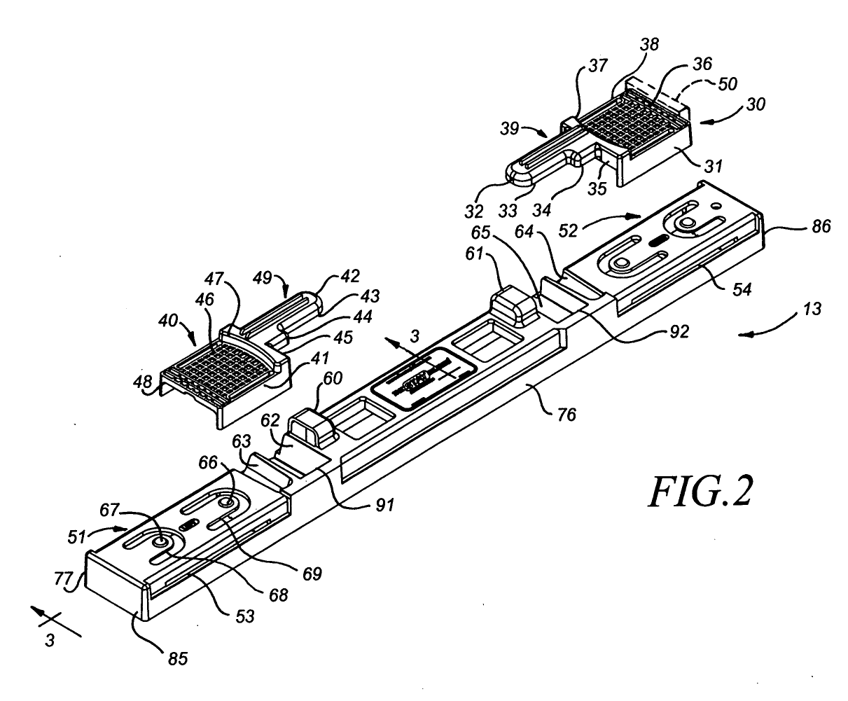

FIG. 2 is a perspective view illustrating a support utilized in the signage system of FIG. 1;

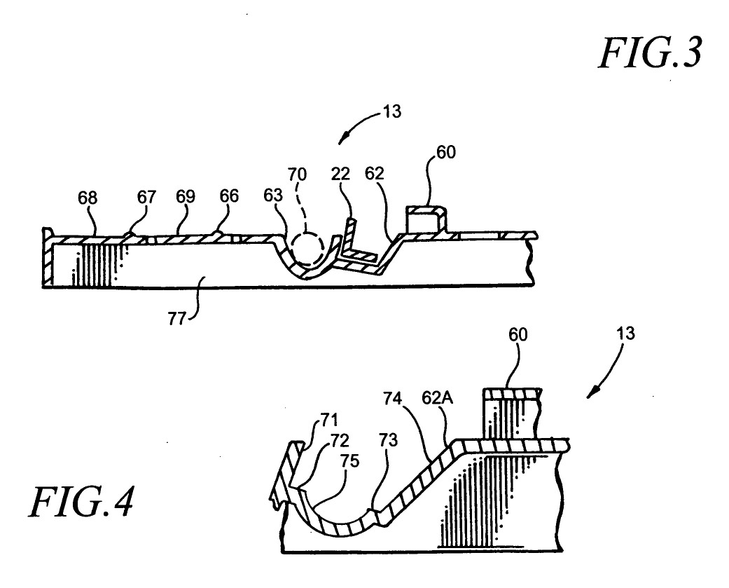

FIG. 3 is a section view of a portion of the support of FIG. 2 illustrating additional construction details thereof and taken along section line 3-3 thereof; and,

FIG. 4 is a section view of the support of FIG. 2 illustrating an alternate construction of a foot seating opening formed therein.

Briefly, in accordance with the invention, we provide an improved counterpoise signage system. The system includes an A-frame sign having a selected weight and including a pair of folding legs each having a foot. The legs are movable between a first operative folded closed position, and a second operative unfolded open position in which the feet of the legs define a footprint on the ground when the feet contact the ground. The system also includes a ground engaging support that includes a first end; a second end; and, an interdigitation structure intermediate the first and second ends. The interdigitation structure removably attaches the support to the feet such that when a force acting on the sign causes one of the ends to lift away from the ground, the other of the ends functions as a fulcrum and the weight of the sign acts to force the one end toward the ground.

In another embodiment of the invention, we provide an improved signage system including including an A-frame sign having a selected weight and including a pair of legs each having a foot spaced apart from the foot on the other leg; and, including a ground engaging support. The support includes a first end; a second end; and, a foot actuated structure for removably attaching the support to at least one of the feet.

In a further embodiment of the invention, we provide an improved constricting signage system. The system includes an A-frame sign having a selected weight and including a pair of folding legs each having a foot. The legs are movable between a first operative folded closed position, and a second operative unfolded open position in which the feet of the legs define a footprint on the ground when the feet contact the ground. The signage system also includes a ground engaging support. The support includes a first end; a second end; and, a system intermediate the first and second ends to engage the feet when the folding legs are in the second operative position to constrict movement of the legs from the second operative position to the first operative position.

In still another embodiment of the invention, we provide an improved signage system. The system includes an A-frame sign having a selected weight and including a pair of folding legs each having a foot. The legs are movable between a first operative folded closed position, and a second operative unfolded open position in which the feet of the legs define a footprint on the ground when the feet contact the ground. The signage system also includes a ground engaging support. The support includes a first end; a second end; and, a system intermediate the first and second ends to engage the feet when the folding legs are in the second operative position to constrict lateral movement of the feet in the support.

In still a further embodiment of the invention, we provide an improved signage system. The system includes an A-frame sign having a selected weight and including a pair of folding legs each having a foot. The legs are movable between a first operative folded closed position, and a second operative unfolded open position in which the feet of the legs define a footprint on the ground when the feet contact the ground. The system also includes a ground engaging support including a first end; a second end; and, a system intermediate the first and second ends to engage the feet when the folding legs are in the second operative position, the system being shaped and dimensioned to engage a plurality of feet each having a different shape and dimension.

Turning now to the drawings, which depict the presently preferred embodiments of the invention for the purpose of illustrating the practice thereof and not by way of limitation of the scope of the invention and in which like reference characters refer to corresponding elements throughout the several views, FIG. 1 illustrates a signage system constructed in accordance with the principles of the invention and generally indicated by reference character 10. The signage system 10 includes an A-frame sign 11 and supports 12 and 13 operatively associated with sign 11. When the sign 11 is in the unfolded erect configuration illustrated in FIG. 1, the sign has the appearance of an A-frame. The shape and dimension and construction of support 12 is equivalent to that of support 13.

A-frame sign 11 includes a frame that comprises a rectangular frame member 14 pivotally attached with pins 23 to a U-shaped frame member 15.

Rectangular frame member 14 includes legs 20 and 21, foot 22 interconnecting the bottom or lower ends of legs 20 and 21, and top 19 interconnecting the upper ends of legs 20 and 21.

U-shaped frame member 15 includes legs 16 and 17 and foot 18 interconnecting the bottom or lower ends of legs 16 and 17. The upper ends of legs 16 and 17 are each pivotally secured to the upper ends of legs 20 and 21, respectively, by a pin 23. Frame members 14 and 15 are constructed from angle iron but can, as would be appreciated by those of skill in the art, be constructed from any desired material having any desired shape and dimension.

A display panel, indicated by dashed line 24, is suspended and hangs from the top 19 and is generally normal to the ground unless displaced by wind or some other force indicated by arrow B. Alphanumeric characters and artwork are typically imprinted or otherwise formed on the front and back parallel faces of panel 24. By way of example, and not limitation, the logo and name of a real estate company can be formed on the front and back faces of panel 24. Frame members 14 and 15 are open and permit ready viewing of the front and back surfaces of panel 24.

A handle 25 is attached to top 19.

When sign 11 is not mounted on supports 12 and 13, members 14 and 15 can be pivoted about pins 23 to fold toward one another to a closed position, i.e., legs 15 and 21 can be folded toward one another and legs 16 and 20 can be folded toward one another (or, if member 14 is maintained in a stationary position, leg 15 can be folded toward leg 21 simultaneously with leg 16 being folded toward leg 20, etc.) In the manner indicated in FIG. 1 by arrows C and D. FIG. 1 illustrates sign 11 when members 14 and 15 and the legs thereof are in the unfolded open position.

Elongate support member 13 is illustrated in greater detail in FIG. 2. Member 13 includes ends 85 and 86, front side 76, back side 77, foot-actuated members 30 and 40, and sleeves 60 and 61.

Member 30 slides back and forth on slide 52 between a first open operative position and a second closed operative position. The closed operative position of member 30 is illustrated in FIG. 1.

Member 40 slides back and forth on slide 51 between a first open operative position and a second closed operative position. The open operative position of member 40 is illustrated in FIG. 1.

Member 30 includes downwardly extending parallel spaced apart sides or legs 31 and 38. Leg 31 includes a foot that is shaped and dimensioned to be slidably received by a slot 54 formed in front side 76. Leg 38 includes a foot that is shaped and dimensioned to be slidably received by a slot 55 (FIG. 1) formed in the back side 77.

Member 40 includes downwardly extending parallel spaced apart sides or legs 41 and 48. Leg 41 includes a foot that is shaped and dimensioned to be slidably received by a slot 53 formed in front side 76. Leg 48 includes a foot that is shaped and dimensioned to be slidably received by a slot 56 formed in back side 77.

Member 30 includes a tongue 39 having a distal end 32, a first side control surface 33, a second side control surface 34, and a base control surface 35. Surface 35 is normal to surface 34. When a sign 11 is mounted in a support member 12 or 13 in the manner illustrated in FIG. 1, and when member 30 is moved from the open position in the direction of arrow G to the closed position (which closed position is illustrated on support members 12 and 13 in FIG. 1), tongue 39 and surfaces 35, 33 and/or 34 function to interdigitate and secure a foot 18, 22 in a support member 12, 13.

Member 40 includes a tongue 49 having a distal end 42, a first side control surface 43, a second side control surface 44, and a base control surface 45. Surface 45 is normal to surface 44. When a sign 11 is mounted in a support member 12 or 13 in the manner illustrated in FIG. 1, and when member 40 is moved from the open position (illustrated on support members 12 and 13 in FIG. 1) to the closed position (which closed position is similar to that of member 30), tongue 49 and surfaces 45, 43 and/or 44 function to interdigitate and secure a foot 18, 22 in a support member 12, 13.

When a support member 13 (or 12) is setting on the ground with a sign 11 mounted therein in the manner illustrated in FIG. 1, a user can—while standing—readily operate a member 30 by grasping handle 25 or another part of sign 11, by placing the toe or ball of his or her shoe on foot surface 36, and by using his or her shoe (or foot) and leg to slide support member 30 along slide 52 in the direction of arrow G or in the opposing direction. When the tip or front of the user's shoe (or foot) is resting on surface 36, the user can position one edge of the shoe against stop surface 37 to provide the user with more control over movement of member 30 with the foot. If desired, member 30 (and member 40) can be constructed with an extended foot stop or guide, indicated by dashed lines 50 in FIG. 2, similar to stop 37 located at the rear of surface 36.

When a support member 13 (or 12) is setting on the ground with a sign 11 mounted therein in the manner illustrated in FIG. 1, a user can—while standing—readily operate a member 40 by grasping handle 25 or another part of sign 11, by placing the toe or ball of his or her shoe (or foot) on foot surface 46, and by using the shoe to slide support member 40 back and forth along slide 51 between the open and closed position of member 40. When the front of the user's shoe is resting on surface 46, the user can position one edge of the shoe against vertically oriented stop surface 47 to provide the user with more control over movement of member 40 with the foot.

Slide 51 includes resilient tongues 68, 69 provided with upstanding dimples 67 and 66, respectively. When member 40 is in the open position, dimple 67 removably slidably conforms to and engages a semi-spherical opening (not visible) formed on the under surface of member 40. When member 40 is moved from the open toward the closed position, dimple 67 and tongue 68 are resiliently, downwardly displaced such that dimple 67 moves out of the semi-spherical opening and the under surface of member 40 slides over dimple 67 (and dimple 66). When member 40 reaches the closed position, tongue 69 upwardly resiliently displaces dimple 66 into said semi-spherical opening formed on the under surface of member 40. Accordingly, dimples 66, 67 function to secure movably member 40 in the open and closed position.

As can be seen in FIG. 2, the construction of slide 52 is identical to that of slide 51, and slide 52 and member 30 are operated in the same manner as slide 51 and member 40.

When member 40 is in the closed position, distal end 42 is housed inside sleeve 60.

When member 30 is in the closed position, distal end 32 is housed inside sleeve 61.

In FIG. 1, when member 30 on support member 12 is (as illustrated in FIG. 1) in the closed position, control surface 33 is adjacent leg 20 and above foot 22. Surface 33 and the bottom surfaces of tongue 39 normally do not, but can, directly contact leg 20 or foot 22. When member 40 on support member 12 is in the closed position (in FIG. 1, member 40 is illustrated in the open position), control surface 43 is adjacent leg 16 and above foot 18. Surface 43 and the bottom surfaces of tongue 49 normally do not, but can, directly contact leg 16 or foot 18. When member 30 on support member 13 is (as shown in FIG. 1) in the closed position, control surface 33 is adjacent leg 17 and above foot 18. Surface 33 and the bottom surfaces of tongue 39 normally do not, but can, directly contact leg 17 or foot 18. When member 40 on support member 13 is in the closed position, control surface 43 is adjacent leg 21 and above foot 22. Surface 43 and the bottom surface of tongue 49 normally do not, but can, directly contact leg 21 or foot 22.

As is illustrated in FIGS. 2 and 3, member 13 includes two sets of foot-receiving grooves. The first set comprises inner grooves 62 and 65. The second set comprises outer grooves 63 and 64. The first set of grooves 62, 65 is shaped and dimensioned to generally conform to and receive feet 18 and 22 that are constructed from angle iron and that are canted when a sign 11 is in the open, unfolded configuration illustrated in FIG. 1. FIG. 3 illustrates how an angle iron foot 22 seats in and generally conforms to a groove 62. In contrast, the second set of grooves 63, 64 is shaped and dimensioned to generally conform to and receive feet having a cylindrical shape like that depicted by dashed lines 70 in FIG. 3.

In FIG. 4, support member 13 is modified by replacing groove 62 with a groove 62A that is shaped and dimensioned to receive either a foot 18, 22 made from angle iron or a cylindrically shaped foot. Flat surfaces 71, 72, 73, 74 in groove 62A are shaped to receive and support a foot 18, 22 made from angle iron. Arcuate surface 75 is shaped to support a cylindrically shaped foot that is seated thereon. As would be appreciated by those of skill in the art, the shape and dimension of grooves 62 to 65 can be altered as desired to facilitate the seating and containment therein of a foot 18, 22 having any selected shape and dimension. One or more sets of grooves can be utilized in a support member 12, 13.

Surfaces 91 and 92 function to prevent the lateral movement in the directions indicated by arrows E and F (FIG. 1) of a foot 18 seated in grooves 62 and 65.

Members 30 and 40 can, in addition to being foot operated, be manually slidably opened and closed.

In use, a pair of supports 12, 13 is provided. A folded, closed A-frame sign 10 is provided. Support members 12, 13 are placed on the ground in the spaced apart relationship shown in FIG. 1. The members 14, 15 of sign 10 are pivoted apart in directions opposite those indicated by arrows C and D and are unfolded to the open orientation shown in FIG. 1. Members 30 and 40 are moved along their respective slides 52 and 51 to the open position. The ends of foot 18 are seated in groove 65 of support member 13 and groove 62 of support member 12. The ends of foot 22 are seated in groove 62 of support member 13 and groove 65 of support member 12. Each member 30, 40 is slid from the open to the closed position to interdigitate the ends of feet 18 and 22 in support members 12 and 13.

An alternate, more convenient, method for a user to install sign 10 in support members 12 and 13 is to first place a support member 13 on the ground, to move members 30 and 40 on member 13 to their open positions, to seat one end of foot 18 in groove 65, to seat one end of foot 22 in groove 62, and for the user to employ one of his feet to slidably displace each member 30 and 40 from the open to the closed position. Member 12 is then placed on the ground with members 30 and 40 thereof each in the open position. The other end of foot 18 is seated in groove 62 of member 12. The other end of foot 22 is seated in groove 65 of member 12. The user utilizes one of his or her feet to slidably displace each member 30 and 40 on member 12 from the open to the closed position.

To move a member 30, 40 from the open to the closed position, the user places one of his feet on surface 36 or 46, as the case may be, and uses his foot to displace member 30 or 40. The user also typically grasps handle 25 or a portion of sign 11 while moving a member 30 or 40 with his or her foot. The constriction of feet 18 and 22 in members 12 and 13 effectively turns sign 11 into a rigid, relatively stiff, strong structure. Such constriction prevents legs 20 and 21 from folding and closing toward legs 16 and 17. Surfaces 91, 92, 33 and 43 cooperatively function to prevent or limit lateral movement of feet 18, 22 and the lower ends of legs 16, 17, 20, 21 in support members 12 and 13. Although members 30, 40 interdigitate feet 18 and 22 in grooves 62, 65 formed in members 12 and 13, it is preferred that tongues 39 and 49 not fit too tightly against feet 18 and 22 when members 30 and 40 are in the closed position. A tight fit between tongues 39, 49 and feet 18, 22 can make it difficult to operate members 30, 40 and to push members 30, 40 from the open to the closed position.

The base portion of tongue 39 includes surface 34. The distal portion of tongue 39 includes surface 33. The base portion of tongue 39 is wider than the distal portion because the base portion is—when a sign with cylindrically shaped legs is inserted in supports 12 and 13 instead of the angle iron sign 10 illustrated in FIG. 1—adjacent a cylindrically shaped leg 17 or 20 that has a different shape and dimension than an angle iron leg. The base portion of tongue 49 is similarly wider than the distal portion of tongue 49 for the same reason. The shape and dimension of each tongue 39, 49 can vary as desired in order for the tongue to be sufficiently close to or spaced apart from a leg 16, 17, 20, 21 or foot 18, 22 such that feet 18, 22 are interdigitized in support member 13. A tongue 39, 49 can, for example, be shaped to engage a slot or opening formed in a leg 16, 17, 20, 21 or foot 18, 22 when member 30, 40 is in the closed position.

The capture by members 12 and 13 of legs 18 and 22 at points intermediate ends 85 and 86 is desirable in the counterpoising of signage system of FIG. 1. Wind or some other means can generate a force, indicated by arrow B in FIG. 1, that acts against sign 11 and causes end 86 of member 13 and end 85 of member 12 to raise off the ground in the direction indicated by arrows A in FIG. 1. Since end 85 of member 13 and end 86 of member 12 remain on the ground, these ground engaging ends function as the fulcrum in a lever system, and the weight of sign 11 generates a force, indicated by arrow W, that works to displace the levers (i.e., members 12 and 13) downwardly toward the ground and to counteract the force tending to raise end 86 of member 13 and end 85 of member 12 upwardly from the ground in the direction of arrows A. The constriction of feet 18 and 22 by support members 12 and 13 further decreases the likelihood that the desired open, upright orientation of sign 11 will be permanently altered.

The presently preferred embodiments of the signage system of the invention incorporate A-frame signs. It is understood, however, that supports 12 and 13 may be used in combination with signs that are not A-frame signs.

Each support member 12, 13 can include one or more foot-receiving slots 62 to 65 and can include one or more members 30, 40. A support member 12, 13 with only a single slot requires only a single member 30 or a single member 40.

When members 30 and 40 are each in the open position, sign 11 is removed from support members 12 and 13 by grasping handle 25 and lifting sign 11 upwardly in the direction of arrow H to remove feet 18 and 22 from support members 12 and 13.

Lock, latches, screws, or any other desired fastening apparatus can be utilized to secure legs 18, 22 to members 12 and 13 in combination with or in place of members 30, 40. It is preferred that any such fastening apparatus permit legs 18, 22 to be removed from members 12 and 13.

By way of example, in an A-frame sandwich board, each board or panel is a leg and the feet consist of the lower ground contacting edges or portions of the panels.

Having set forth our invention in terms to enable those skilled in the art to understand and practice the invention and having set forth the presently preferred embodiments and uses thereof,

1. A counterpoise signage system including
(a) an A-frame sign having a selected weight and including a pair of folding legs each having a foot, said legs movable between
(i) a first operative folded closed position, and
(ii) a second operative unfolded open position in which said feet of said legs define a footprint; and,
(b) a ground engage support including
(i) a first end,
(ii) a second end, and,
(iii) an interdigitation structure intermediate said first and second ends for removably attaching said support to said feet such that when a force acting on said sign causes one of said ends to lift away from the ground, the other of said ends functions as a fulcrum and the weight of said sign acts to force said one end toward the ground.

2. A signage system including
(a) an A-frame sign having a selected weight and including a pair of legs each having a foot spaced apart from the foot on the other leg; and,
(b) a ground engaging support including
(i) a first end,
(ii) a second end, and,
(iii) a foot actuated structure for removably attaching said support to at least one of said feet.

3. A constricting signage system including
(a) an A-frame sign having a selected weight and including a pair of folding legs each having a foot, said legs movable between
a first operative folded closed position, and
a second operative unfolded open position in which said feet of said legs define a footprint; and,
(b) a ground engaging support including
(i) a first end,
(ii) a second end, and,
(iii) a system intermediate said first and second ends to engage said feet when said folding legs are in said second operative position to constrict movement of said legs from said second operative position to said first operative position.

4. A signage system including
(a) an A-frame sign having a selected weight and including a pair of folding legs each having a foot, said legs movable between
(i) a first operative folded closed position, and
(ii) a second operative unfolded open position in which said feet of said legs define a footprint; and,
(b) a ground engaging support including
(i) a first end,
(ii) a second end, and,
(iii) a system intermediate said first and second ends to engage said feet when said folding legs are in said second operative position to constrict lateral movement of said feet in said support.

5. A signage system including
(a) an A-frame sign having a selected weight and including a pair of folding legs each having a foot, said legs movable between
(i) a first operative folded closed position, and
(ii) a second operative unfolded open position in which said feet of said legs define a footprint; and,
(b) a ground engaging support including
(i) a first end,
(ii) a second end, and,
(iii) a system intermediate said first and second ends to engage said feet when said folding legs are in said second operative position, said system being shaped and dimensioned to engage a plurality of feet each having a different shape and dimension.
